(19) United States
(12) Patent Application Publication
(10) Pub. No.: US 2003/0150851 A1
(43) Pub. Date: Aug. 14, 2003

(54) Method of increasing the length of life of heating elements at low temperatures

(76) Inventor: Mats Sundberg, Vasteras (SE)

Correspondence Address: ALFRED J MANGELS, 4729 CORNELL ROAD, CINCINNATI, OH, 452412433

(21) Appl. No.: 10/275,168

(22) PCT Filed: May 16, 2001
(86) PCT No.: PCT/SE01/01081

(30) Foreign Application Priority Data
May 18, 2000 (SE) 0001846-5

(51) Int. Cl. H05B 3/10

(52) U.S. Cl. 219/548

(57) ABSTRACT

A method of lengthening the useful life of heating elements that are essentially comprised of molybdenum silicide and molybdenum tungsten silicide and different alloys of these basic materials, when the elements are operated at a relatively low temperature, such as a temperature in the range of 400-800° C., The invention is characterised in that the atmosphere surrounding the elements as they operate is caused to have a water content that is less than about one percent by volume.

A method of increasing the length of life of heating elements at low temperatures The present invention relates to method of lengthening the useful life of heating elements at low temperatures and more specifically the useful life of elements that comprise molybdenum silicide and molybdenum tungsten silicide, including different alloys of these basis materials. Such elements are produced by Applicant in a relatively large number of applications.

When such elements are operated at relatively low temperatures, for example at temperatures around 400-500° C., no protective silica scale (so-called glass layer) will form, as opposed to when operating the elements at high temperatures. Instead, the elements are subjected to so-called pest, meaning that a non-protective layer of MoO₃ and SiO₂ forms on the surfaces of the elements. This mixture is porous and readily disintegrates, resulting in a significant shortening of the useful life of the elements.

However, there are applications in which such elements are, nevertheless, the best alternative. One example in this regard is found in the heating of LPCVD-chambers, (Low pressure Chemical Vapour Deposition) in the manufacture of electronic circuits.

The low temperature properties of such heating elements can be improved, by pre-oxidising the elements at a temperature of about 1500° C. or higher, so as to form a skin of SiO₂. Such a skin will slow down the formation of pest.

The proposed method greatly lengthens the useful life of such heating elements.

The present invention thus relates to a method of lengthening the useful life of heating elements that are essentially comprised of molybdenum silicide and molybdenum tungsten silicide and different alloys of these basic materials, when said elements are operated at a low temperature, such as a temperature in the range of 400-800° C., wherein the method is characterised by causing the atmosphere that surrounds the elements when said elements are operated to have a water content that is less than about one percent by volume.

The present invention is based on the surprising insight that the oxide products MoO₃ and SiO₂ are formed to a much less extent when the water content of the gas surrounding the elements is kept to a low level, despite the oxygen content of the gas being very high.

The invention will now be described in more detail with reference to the accompanying drawing, in which

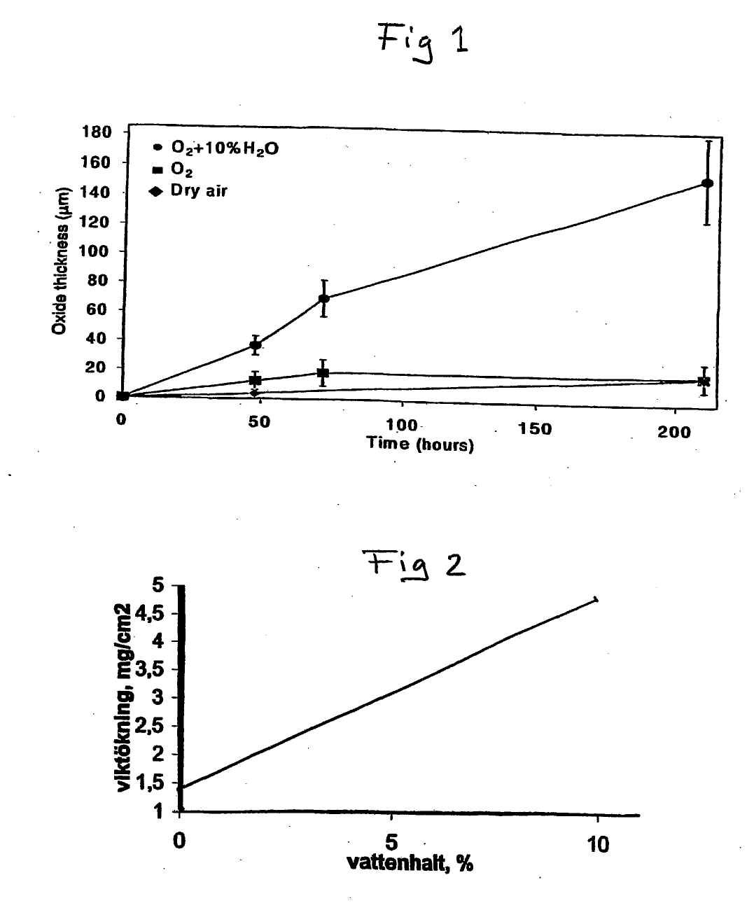

FIG. 1 is a diagram that illustrates oxide thickness as a function time in respect of different gases, and

FIG. 2 illustrates the increase in weight caused by oxidation as a function of the water content of the surrounding gas.

The present invention relates to a method of lengthening the useful life of heating elements that are essentially comprised of molybdenum silicide and molybdenum tungsten silicide and different alloys of these basic materials when the elements are operated at a relatively low temperature, such as a temperature in the range of 400-800° C. It is at this temperature range that such elements are subjected to so-called pest. The temperature at which the elements are operated varies in accordance with the process in which the elements are used on the one hand, and in accordance with the composition of the material from which the elements are made on the other hand.

Pest is the formation of MoO₃ and SiO₂ from MoSi₂ and O₂. This oxide mixture is relatively porous and does not therefore afford any protection against continued oxidation.

According to invention, the atmosphere surrounding the elements as the operate is caused to have a water vapour content of less than about one percent by volume. This results in a marked decrease in the growth of pest.

FIG. 1 shows the oxide thickness of MoO₃ and SiO₂ in different atmospheres at 450° C. By dry air in FIG. 1 is meant that the air has a water content of 0.0005 percent by volume. The oxygen gas (O₂) is correspondingly dry. By O₂+10% H₂O is meant oxygen gas with 10 percent by volume water.

It will be evident from FIG. 1 that the oxide growth has been greatly limited and is essentially the same for both dry air and dry oxygen gas, whereas rate of growth is more than ten times faster when the surrounding atmosphere contains ten percent by volume water.

FIG. 2 shows the weight increase of a material caused by the formation of said oxides as a function of the water content in percent by volume of the atmosphere surrounding the heating elements at an element temperature of 450° C.

As will be evident from FIG. 2, the oxidation, the pest formation, increases linearly with the water content. It has been established that different oxide structures are formed at different water contents of the surrounding atmosphere.

An oxide consisting of MoO₃-crystals embedded in amorphous SiO₂ had formed after 72 and 210 hours respectively at 450° C. The quantity ratio between these two oxides appeared to be constant.

Much larger MoO₃-crystals were formed after 72 and 210 hours respectively in an oxygen gas atmosphere that contained 10 percent by volume water. The proportion of SiO₂ in relation to the proportion of MoO₃ also appeared to decrease with time. The water content of the surrounding atmosphere thus influenced the structure and the quantity ration of the oxides formed. The structure and quantity ratio of the formed oxides is a probable explanation of the large differences in oxide growth, as discussed above, in relation to the water content of the surrounding gas.

It can also be noticed that the amount of oxygen in the surrounding atmosphere has no significant influence on the oxide growth.

As mentioned in the introduction, the aforesaid elements are used at said temperatures in certain industrial processes.

As beforementioned, the present invention is characterised by causing the water content of the surrounding atmosphere to lie beneath about one percent by volume. FIG. 2 shows that the oxide growth is therewith only slightly greater than in the case of a completely dry atmosphere.

However, it is preferred to bring the water content to a level that is less than about 0.5 percent by volume.

According to one preferred embodiment of the invention, the atmosphere surrounding the elements is comprised of air that has the aforesaid water content. Air of this dryness can be produced with the aid of commercially available plant and apparatus. Dry air is also available in air cylinders.

According to another preferred embodiment, the atmosphere is comprised of oxygen gas that has the aforesaid water content. Bottled dry oxygen gas can be used to this end.

The atmosphere chosen will depend on the process in which the heating elements are used.

Atmospheres other than air and oxygen gas will probably give a corresponding result with respect to the formation of oxides, provided that the atmosphere has a water content according to the invention. For example, it is likely that nitrogen gas or an inert gas can be used.

The present invention shall not therefore be considered to be limited to the aforesaid atmospheres surrounding the elements.

1. A method of lengthening the useful life of heating elements that are essentially comprised of molybdenum silicide and molybdenum tungsten silicide and different alloys of these basic materials when the elements are operated at a relatively low temperature, such as a temperature in the range of 400-800° C., characterised in that the atmosphere surrounding the elements as they operate is caused to have a water content that is less than about one percent by volume.

2 A method according to claim 1, characterised in that the atmosphere consists of air that has a water content of less than about one percent by volume.

3. A method according to claim 1, characterised in that the atmosphere consists of oxygen gas that has a water content of less than about one percent by volume.

4. A method according to claim 1, 2 or 3, characterised in that the water content is caused to lie beneath about 0.5 percent by volume.
